(19) United States
(12) Patent Application Publication
(10) Pub. No.: US 2006/0198347 A1
(43) Pub. Date: Sep. 7, 2006

(54) Accessing a communication system

(75) Inventors: Tuija Hurtta, Espoo (FI); Serge Haumont, Espoo (FI); Tuomas Niemela, Helsinki (FI); Kari Kauranen, Helsinki (FI); Timo Leppakorpi, Espoo (FI); Miikka Huomo, Vantaa (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/119,735

(22) Filed: May 3, 2005

(30) Foreign Application Priority Data
Mar. 3, 2005 (FI) 20050235

(51) Int. Cl. H04Q 7/24

(52) U.S. Cl. 370/338

(57) ABSTRACT

A method provides control of access in a communication system. The method includes providing an access route via at least one unlicensed radio spectrum access network and via at least one licensed radio spectrum access network. The method further includes receiving an access request from a cell belonging to one of the at least one unlicensed radio spectrum access network and the at least one licensed radio spectrum access network. The method further includes determining whether the access request is received from a cell belonging to the at least one unlicensed radio spectrum access network or the at least one licensed radio spectrum access network. The method further includes controlling the access based on a result of the step of determining. Furthermore, a network element, a computer program and a communication system are configured to execute the method.

### FIELD OF THE INVENTION

The invention relates to communication systems. More particularly the invention relates to accessing a communication system, controlling the access and obtaining information on access types.

### BACKGROUND OF THE INVENTION

A communication system can be seen as a facility that enables communication sessions between two or more entities such as one or more communication devices and/or other nodes associated with the communication system. A communication system typically operates in accordance with a given standard or specification setting out what the various entities associated with the communication system are permitted to do and how that should be achieved. A standard or specification may define a specific set of rules, such as communication protocols and/or parameters, on which connections between the entities can be based.

Wireless communication systems include various cellular or otherwise mobile communication systems using radio frequencies for sending voice or data between stations, for example between a communication device and a transceiver network element. National or international authorities or organizations may allocate a radio frequency band, so-called licensed radio frequencies, to mobile communication networks. Examples of mobile communication systems operating on a licensed spectrum may comprise public land mobile network (PLMN), such as global system for mobile communication (GSM), the general packet radio service (GPRS) and the universal mobile telecommunications system (UMTS).

A mobile communication network may logically be divided into a radio access network (RAN) and a core network (CN). A communication device may access the communication network via an access entity, such as a transceiver network element, of the RAN. Examples of radio access networks operating on a licensed spectrum may comprise GSM/EDGE radio access network (GERAN) and UMTS terrestrial radio access network (UTRAN).

A single communication system may interface with one or more communication systems, such as with other wireless systems, such as a wireless Internet Protocol (IP) network, wireless local area network (WLAN) and/or fixed line communication systems.

Wireless communication systems may also use unlicensed radio frequencies. Unlicensed Mobile Access (UMA) technology provides access to mobile services over unlicensed spectrum technologies. Examples of unlicensed spectrum technologies may comprise Bluetooth and IEEE 802.11, both operating in an unlicensed 2,4 GHz industrial, scientific and medical (ISM) frequency band.

UMA is an extension of GSM/GPRS mobile services into customer premises achieved by tunneling certain GSM/GPRS protocols between the customer premises and the core network over a broadband IP network. In UMA unlicensed spectrum technologies may be used to carry another access protocol, such as GSM or GPRS, to reach the GSM/GPRS core network when the core network is not directly reachable. From a perspective of an end-user, GSM/GPRS services are used. UMA is a complement to a traditional GSM/GPRS radio coverage, used to enhance customer premises coverage, increase network capacity and potentially lower costs.

A communication device may establish a packet data connection to a UMA network controller (UNC). Each UNC may control a plurality of UMA cells. The UNC may be connected to a controlling or switching element of the mobile communication systems, such as a serving GPRS support node (SGSN), for example via a Gb interface. In the GSM/GPRS, the SGSN is a network element, which typically keeps track of a location of an individual communication device and performs security functions and access control.

It might be desired that the SGSN was able to distinguish cells using UMA from GSM/GPRS cells. This distinction might be useful for various purposes, such as for charging, service authorization, control of service chaining, and so on. It might also be desired that the SGSN, and possibly other elements in the system, could identify an access provider providing the access.

Furthermore, it might be desired to restrict network access from UMA cells. Currently, no mechanism exists for restricting a network access when a user is roaming from an UMA cell. However, accessing a network via the UMA cells may load the network heavily.

### SUMMARY OF THE INVENTION

In accordance with an aspect of the invention, there is provided a method for controlling access in a communication system. The method comprises providing an access route via at least one unlicensed radio spectrum access network and via at least one licensed radio spectrum access network. he method also comprises receiving an access request from a cell belonging to one of the at least one unlicensed radio spectrum access network and the at least one licensed radio spectrum access network. The method also comprises determining whether the access request is received from a cell belonging to the at least one unlicensed radio spectrum access network or the at least one licensed radio spectrum access network. The method also comprises controlling the access based on a result of the step of the determining.

In an embodiment, the access route may be provided via unlicensed mobile access and via general packet radio service.

In an embodiment, a list comprising an identification of each cell belonging to the at least one unlicensed radio spectrum access network may be verified and the access request may be determined to be received from a cell belonging to the at least one unlicensed radio spectrum access network when said cell is found on the list. In an embodiment, the list may comprise a routing area identity of cells belonging to the at least one unlicensed radio spectrum access network.

In an embodiment, the access request may be received over an Iu interface from a controller comprising one of an unlicensed mobile access network controller and radio network controller. In an embodiment, an identification of the controller from which the access request is received may be determined, a list comprising an identification of each unlicensed mobile access network controller belonging to the at least one unlicensed radio spectrum access network may be verified and the access request may be determined to be received from a cell belonging to the at least one unlicensed radio spectrum access network when the controller network element is found on the list.

In an embodiment, location information may be received when the access route changes. In an embodiment, information on the at least one unlicensed radio spectrum access network may be received through Gb interface when a cell is setup. In an embodiment, information on the at least one unlicensed radio spectrum access network in uplink packets may be received through Gb interface together with a cell identifier.

In an embodiment, the access request may be received over a Gb interface from a network element, an identification of the network element may be determined, a list may be verified, which list comprises an identification of each network service element associated with an unlicensed mobile access network controller and which network service element is dedicated for unlicensed mobile access, and the access request may be determined to be received from a cell belonging to the at least one unlicensed radio spectrum access network when the network service element is found on the list.

In an embodiment, access restriction information may be received for a subscriber from a subscriber database associated with the subscriber, the access restriction information comprising information on at least one of access restrictions and access permissions from at least one unlicensed mobile access network.

In an embodiment, charging information may be generated based on a the result of the step of determining.

In accordance with another aspect of the invention, there is provided a computer program comprising program code means for performing any of the steps of the method according to embodiments of the invention when the program is run on a computing means.

In accordance with another aspect of the invention, there is provided a network entity for a communication system. The network entity is configured to provide an access route via at least one unlicensed radio spectrum access network and via at least one licensed radio spectrum access network. The network entity is further configured to receive an access request from a cell belonging to one of the at least one unlicensed radio spectrum access network and the at least one licensed radio spectrum access network. The network entity is further configured to determine whether the access request is received from a cell belonging to the at least one unlicensed radio spectrum access network or the at least one licensed radio spectrum access network. The network entity is further configured to control the access based on a result of the determining.

In accordance with another aspect of the invention, there is provided a communication system. The communication system comprises a first network entity configured to determine an access type from an access request received from one of a cell belonging to an unlicensed radio spectrum access network and a licensed radio spectrum access network, and to control an access according to said access type using access restriction information. The communication system further comprises a second network entity configured to provide the access restriction information for a subscriber associated with the access request, the access restriction information comprising information on at least one of access restrictions and access permissions from at least one unlicensed mobile access network.

### BRIEF DESCRIPTION OF THE DRAWINGS

The invention will now be described in further detail, by way of example only, with reference to the following examples and accompanying drawing, in which:

FIG. 1 shows an example of an arrangement in which the embodiments of the invention may be implemented;

FIG. 2 shows UMA functional architecture; and

FIG. 3 shows a flow chart illustrating an embodiment of the invention.

### DETAILED DESCRIPTION OF PREFERRED EMBODIMENTS

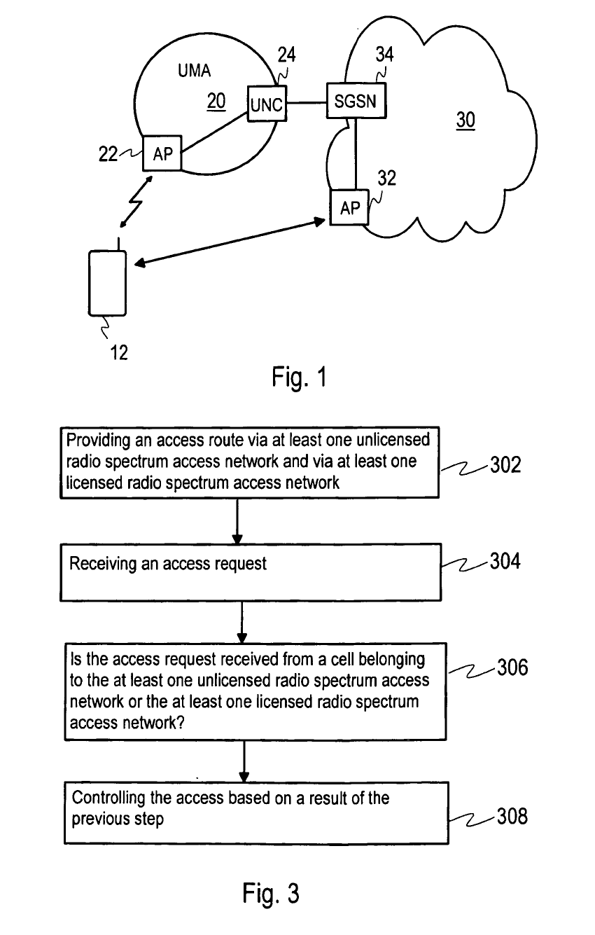

FIG. 1 shows an exemplifying arrangement in which embodiments of the invention may be implemented. The arrangement of FIG. 1 comprises a first access network 20 and a communication network 30. A communication device 12 may be able to access the communication network 30 via the first access network 20 or via a second access network or by other access means.

The communication device 12 used by an end-user for accessing at least one of the networks 20, 30 may be any appropriate communication device, also called terminal. Examples may comprise user equipment (UE), a mobile station (MS), a cellular phone, a personal digital assistant (PDA) and a personal computer (PC). The communication device 12 may comprise a multimode communication device, which is able to communicate with multiple different networks. A communication device, which is able to communicate with two different networks, may be called a dual-mode communication device. Furthermore, the communication device 12 may support multiple radio access technologies to communicate with a single core network, such as with the communication network 30, and thus alternative access methods for the same services. The radio frequencies and the communication protocols may be different in these different networks. In particular, the radio frequencies may be licensed in at least one of the different networks and unlicensed in at least one other of the different networks. Examples of communication protocols may comprise, but are not limited to, session initiation protocol (SIP), wireless session protocol (WSP), hypertext transfer protocol (HTTP), transmission control protocol (TCP), and protocols of IEEE 802.11 and Bluetooth.

In an embodiment, a communication device 12 may use unlicensed radio frequencies for communicating with the first access network 20. The communication device 12 may access the first access network 20 via an access point 22. The first access network 20 may be an UMA network and the access point 22 may be an UMA access point, such as a Bluetooth access point or an 802.11 access point. For providing the communication device 12 with access to the communication network 30, a controller network element of the first access network 20, such as an UNC 24, is shown to interface a switching entity of the communication network 30, such as an SGSN 34.

In an embodiment, the communication device 12 may be able to connect the communication network 30 through a second access network via an access point 32, such as a base station, using licensed radio frequencies. The communication network 30 may be a GSM/GPRS network, an UMTS network or another mobile communication network using licensed radio frequencies.

It shall be appreciated that FIG. 1 is only an example showing only one communication network and two access means in connection with one communication device. The number and type of entities concerned in a communication system may differ substantially from that which is shown. The communication networks typically comprise various further switching and other control entities and gateways for enabling the communication for interfacing a single communication network with one or more communication networks. In order to enhance clarity, these further entities are not shown in FIG. 1. A communication system is typically arranged to serve a plurality of communication devices. Furthermore, a communication device may have several simultaneous communication connections to different or heterogeneous networks, for example, but not limiting to, a number of SIP sessions and activated packet data protocol (PDP) contexts. Communication devices may be connected to the communication system from the same or different networks.

It has now been found that the controlling, or switching, entity of the communication network 30, such as the SGSN 34, may be enabled to distinguish UMA cells from cells belonging to systems using licensed radio frequencies, such as the GSM/GPRS. It has also been found that said controlling entity might be made able to restrict or control access from the UMA cells when the controlling entity is made able to distinguish the UMA cells.

Distinguishing UMA cells from cells belonging to systems using licensed radio frequencies may provide advantages in various ways. In charging, different tariffs may be based on access technology. Service authorization may be based on a set of allowed services, which depends on the access type. Control of quality of service (QoS) may be controlled, for example by defining that maximum QoS depends on the access type. Service chaining, such as usage of performance enhancement proxy (PEP) functions, may depend on the access type.

In 3GPP TS 29.060 V6.7.0 (2004-12); 3^{rd} Generation Partnership Project, Technical Specification Group Core Network; General Packet Radio Service (GPRS); GPRS Tunneling Protocol (GTP) across the Gn and Gp interface (Release 6), paragraph 7.7.50, it has been defined that radio access technology (RAT) type comprising one of GERAN, UTRAN and WLAN may be included in GTP and in remote authentication dial-in user service (RADIUS).

GTP is a protocol between GPRS support nodes (GSNs) in an UMTS/GPRS backbone network. GTP includes GTP control plane (GTP-C) and data transfer (GTP-U) procedures. GTP is defined for a Gn interface, which is an interface between GSNs within a PLMN. Furthermore, GTP is defined for the Gp interface between GSNs in different PLMNs. In addition, for WLAN interworking GTP may be used between a Tunnel Termination Gateway (TTG) and a GGSN. In this usage, the RAT shall indicate WLAN.

RADIUS is a system of distributed security that secures remote access to networks and network services against unauthorized access. RADIUS includes an authentication server and protocols used for accessing the server. The server may be installed in customer premises.

Referring back to FIG. 1, UMA network 20 provides access to a mobile communication network, such as the GSM/GPRS network 30, via the UNC 24, which has a Gb interface with the SGSN 34. The UNC 24 corresponds to a cell or a plurality of cells from a point of view of the SGSN 34.

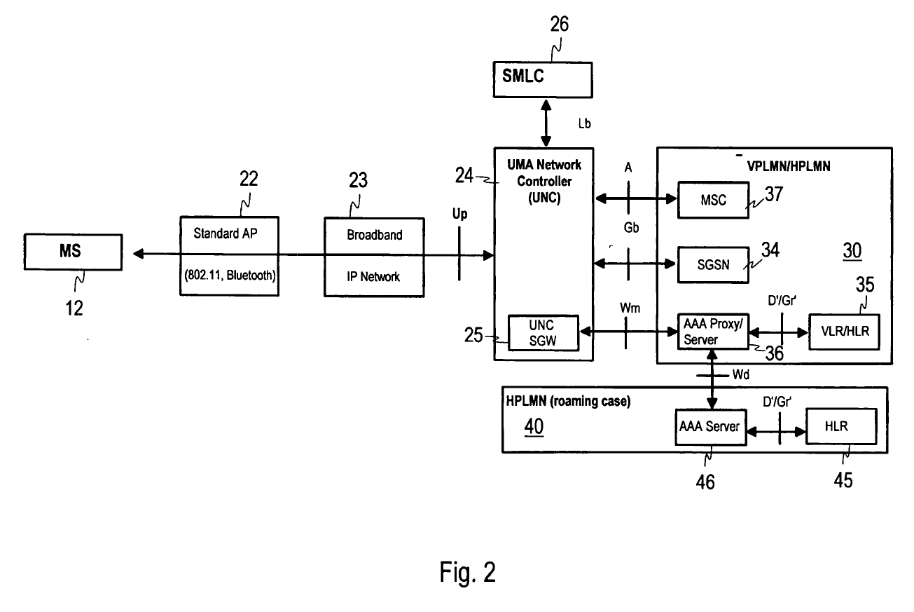

FIG. 2 shows UMA functional architecture. In FIG. 2, a communication device 12 is shown to access a communication system via an access point 22 over a broadband IP network 23. An UMA network controller 24 is shown to interface an SGSN 34 of a visited or home PLMN 30.

In the GSM/GPRS, the SGSN may learn cell identifier information of cells from base station system GPRS protocol (BSSGP) messages called UL-UNITDATA packet data unit (PDU) sent by a base station system (BSS) uplink (UL) over a Gb interface. The BSS comprises a base station controller (BSC) and base stations associated with the BSC.

UMA cells may use the same SGSN than GSM/GPRS cells. However, the BSSGP provides no mechanism to differentiate UMA cells from GSM/GPRS cells. The BSSGP is a procedure of the BSS and provides no means for the SGSN to ask fro information from the BSC.

In an embodiment, an operator operating the SGSN 34 connected to both GSM/GPRS cells and UMA cells might manually configure radio access technology information to the SGSN for each of the cells. In an embodiment, manual configuration might be performed for at least one of UMA cells and GSM/GPRS cells and it might be assumed that the non-configured cells belong to the other of UMA cells and GSM/GPRS cells. For example, a list of UMA cells may be configured to the SGSN. The SGSN can check the list of UMA cells when determining whether the cell is a UMA cell. The list of UMA cells may be formed using routing area identification (RAI), for example. RAI specifies a routing area within a location area, wherein the location area is identified within a PLMN and a country. In a further embodiment, manual configuration might be performed for all cells using any access type.

In 3G networks, a radio network controller (RNC) has an Iu interface with the SGSN or a mobile services switching center (MSC). In a further embodiment, an Iu interface may be introduced also for UMA. This may provide an UMA access to the 3G core network. In 3G, the SGSN knows under which RNC a communication device is located in a packet mobility management (PMM) mode “PMM-CONNECTED”. In an embodiment, an UNC has the Iu interface with the SGSN and the UNC may be considered to correspond to an RNC. The SGSN may then know whether the access is UMA by having a list of UNCs configured to the SGSN. The SGSN can check the list of UNCs when determining whether the access is UMA. If the communication device requesting for an access is found to be located under an UNC configured in the list of the SGSN, the access type is interpreted to be UMA.

In an embodiment, there may be both 3G and UMA service areas under a RNC. A list of UMA service areas or UNCs may be configured to the RNC. The SGSN may receive UMA information through the Iu interface from the RNC together with service area information in a location reporting procedure or in a new Iu procedure. When knowing whether the access type is UMA, the SGSN can set RAT Type accordingly. The RAT Type can be used in various interfaces, e.g. Gn/Gp, Gi/Wi, Gx, Gy, Gz, Ga and Go. The RAT Type may also be added in call detail records (CDRs).

In the embodiment using the location reporting procedure, the SGSN may be configured to request location information only when access type changes. For example, the SGSN may request location information when access type changes from 3G to UMA or vice versa. The RNC may be configured to take this into account and to send location report(s) only at access type change.

In an embodiment, in a radio network layer signalling protocol called Radio Access Network Application Part (RANAP) for the Iu interface, a location reporting control message may be included. A Request type information element (IE) may indicate to the serving RNC whether to report upon change of an RAT or to stop reporting at change of an RAT. If reporting upon change of RAT is requested, the serving RNC shall send a location report message containing the RAT in addition to location information whenever the communication device moves between areas having a different RAT.

In an embodiment, a new Iu procedure, for example a RANAP RAT reporting control message, may be defined to request the RNC to report the RAT type, or any changes of the RAT type. The RAT type may indicate wideband code division multiple access (W-CDMA), Internet high-speed packet access (I-HSPA), or UMA information. An example may comprise the SGSN requesting RAT reporting control from the RNC and the RNC sending RAT report messages containing the requested access information (that is, RAT) to the SGSN. In an embodiment, the request from the SGSN may also be used to request access information when access type changes. In an embodiment, the SGSN may receive UMA information through the Gb interface when UMA cells are setup under the SGSN. In an embodiment, an UMA indication may be included in a Gb message, such as a configuration message. In an embodiment, the SGSN may receive UMA information through the Gb interface together with a cell identifier in uplink packets using the uplink (UL) UNITDATA procedure.

In an embodiment, the UL-UNITDATA PDU shall contain a new optional information element containing the RAT type. New BSCs supporting UMA shall add this information element whenever a logical link control packet data unit (LLC PDU) was sent from a UMA access.

At the BSS and the SGSN, a network service entity (NSE) provides network management functionality required for the operation of the Gb interface. Each NSE is identified by means of a network service entity identifier (NSEI). In an embodiment, an NSE may be dedicated for UMA access. A dedicated UMA NSE may enable configuring in the SGSN the NSEI of the dedicated UMA NSE as an UMA NSEI. All cells relating to the dedicated UMA NSE may then be automatically associated with UMA when an UNC sends related BSSGP Virtual Connection Identifier (BVCI) Reset messages. Instead of configuring every UMA cell independently in the SGSN, only each NSEI need to be configured in this embodiment.

In the embodiment using dedicated UMA NSE, the UNC is preferably implemented in such a way that an NSE is not shared between UMA cells and GSM/GPRS cells. The SGSN provides an operator with an interface to configure the UMA NSEI or a plurality of UMA NSE identifiers.

The SGSN may control access from a GERAN or UTRAN cell based on information received from a home location register (HLR). The SGSN may receive from the HLR a parameter called “Access Restriction Data” in MAP InsertSubscriberData message, while the HLR contains access control information a subscriber. This parameter is specified in 3GPP 29.002 V6.8.0 (2004-12); 3^{rd} Generation Partnership Project; Technical Specification Group Core Network; Mobile Application Part (MAP) specification; (Release 6), paragraph 7.6.3.97. The “Access Restriction Data” parameter tells that a subscriber is allowed to roam in GERAN or UTRAN. The parameter has two possible values: “utranNotAllowed” and “geranNotAllowed”. According to this parameter SGSN can deny the roaming of the subscriber in GERAN or UTRAN. Subscriber roaming in or from UMA is not taken into account in the HLR-based access control and there is no support for UMA values in the “Access Restriction Data” parameter.

Referring back to FIG. 2, UMA has an own authentication (AAA) server. The UNC 24 has a connection to the visited or home location register (VLR/HLR) 35 via the AAA server 36 via Wm and D′/Gr′ interfaces as shown in FIG. 2. The connection may be provided via an UNC security gateway (SGW) 25. In a roaming case, the UNC 24 may have a connection to an AAA server 46 of the home PLMN 40 via the AAA server 36, or AAA proxy, of the visited PLMN 30. The AAA server 46 may be connected to a HLR 45. The UNC 24 may also have a connection with a serving mobile location centre (SMLC) 26. Further appropriate network elements may also be concerned in the system.

In an embodiment, UMA access restrictions for a subscriber are defined in the HLR data of the subscriber. A new HLR parameter “UMA access not allowed, or in an alternative “UMA access allowed”, may be defined for the HLR of the subscriber and as a value for the “Access Restriction Data” in MAP InsertSubscriberData message. The UNC 24 or the SGSN 34 or the MSC 37 or another controlling entity may obtain access restriction information for said subscriber from the HLR 35 of the subscriber. Said controlling entity may restrict or allow access to the network from an UMA cell for said subscriber. In an embodiment, the UNC 24 may restrict access in an authentication phase performed in the AAA server 36. In a further embodiment, the SGSN or the MSC may read the HLR parameter, for example, during attach or routing area update (RAU). The SGSN or the MSC may then restrict access of the subscriber if the HLR parameter requires so.

As has been explained, in embodiments of the invention, a plurality of UMA cells or all UMA cells controlled by one network element, such as one SGSN, may be determined to belong to a single routing area (RA). When a communication device is paged, paging would typically be signalled in all UMA cells of that RA.

Mobility management (MM) activities related to a subscriber may comprise different MM states. The MM states may comprise “idle”, “standby”, and “ready”. In the “ready” state, location information for a communication device on the cell level is provided. The SGSN may comprise so-called Ready timer(s), which is common for the entire SGSN. The Ready timer may cause the communication device being in a “ready” state to be paged only in the current cell. After being idle for a short time, such as for 30 seconds to one minute, the ready timer may typically expire and the communication device move back to a standby mode where paging is again sent to the full routing area. The communication device may also have a ready timer. As long as the communication device is in ready state, the communication device will send cell update, namely uplink packets containing cell Identity, when the communication device changes cells. The SGSN may send the value of the ready timer in the Routing Area Update accept message to the communication device.

However, a typical example of a UMA cell may comprise a private area, such as a home, with a digital subscriber line (DSL) and a UMA access point, such as a Bluetooth, 802.11 or Wi-Fi access point. Therefore, UMA cells are often not connected to each other and there may be little movement in and out of the cells, for example because people tend to stay at home for hours. Therefore, it may not be needed or efficient to perform paging or other such functions in the full routing area.

In an embodiment, parameters associated with some functions or features in access procedures, such as retransmission, timers and security functions, may have different values depending on the radio access technology (RAT). For example, such functions or features may have different values for UMA than for GPRS or UMTS. In an alternative embodiment, different values for some functions or features may be defined depending on a routing area. Profiles or set of parameters may be defined UNC, NSEI or RA specific.

In an embodiment, a timer setting and a routing area may be associated with the radio access technology (RAT). A predetermined timer value may be returned in a routing area update (RAU) accept message, for example. In an embodiment, the predetermined timer value may be set to an infinite value such that the communication device locating in the routing area associated with UMA cells remains all the time in the ready state. In consequence, paging will be performed only in one cell, namely in the cell where the communication device was located when the predetermined timer value was received. However, a number of cell updates need not to be increased, as when the communication device is moved out from said cell, a outing area update (RAU) is anyway performed.

Examples of functions or features, for which associated parameters might be defined, may comprise mobility management (MM) or session management (SM) timers, such as the Ready timer, a mobile station reachable timer (MSRT), a periodic routing area update (PRAU) timer and so on. Compared to the GSM/GPRS or UMTS technologies, the UMA technology typically may be faster, round trip time (RTT) may be shorter and transport channels may be active for longer periods of time. In an embodiment, it may therefore be desired to set longer times for some timers, such as Ready timers. Some other timers, such as MRST and PRAU timers, might be set differently, for example based on an available SGSN signalling capacity.

Further examples of functions or features may comprise retransmissions, such as MM/SM procedures, paging and so on, international mobile equipment identity (IMEI) check related parameters and authentication related parameters. In an embodiment, signalling towards a communication device using UMA may have shorter retransmission intervals and possibly only few retries may be performed. Many retransmissions may not be needed, when TCP is used, for example.

Further examples of functions or features may comprise overload control of UMA traffic. UMA data throughput might be a problem, for example, if UMA radio link control and uplink flow control (URLC-UFC) does not function properly. Furthermore, UMA subscriber count and throughput may be controllable, for example limited. For example, if a communication device does not receive packet switched (PS) services via UMA, the communication device could use UMA for circuit switched (CS) services only and receive or use PS services via another communication system, such as via the GPRS.

FIG. 3 shows a flow chart illustrating an embodiment of the invention. In step 302, an access route is provided via at least one unlicensed radio spectrum access network and via at least one licensed radio spectrum access network. In step 304, an access request is received from a cell belonging to one of the at least one unlicensed radio spectrum access network and the at least one licensed radio spectrum access network. In step 306, it is determined whether the access request is received from a cell belonging to the at least one unlicensed radio spectrum access network or the at least one licensed radio spectrum access network. In step 308, the access is controlled based on a result of the step of the determining.

It shall be appreciated that also other elements in the system may be able determine whether the access type is UMA. In an embodiment, cell identifiers of cells may be known to the other elements and cells for UMA access may be configured to the other elements. Also other embodiments described in connection with the SGSN may be applicable in other elements. Such other elements may comprise a gateway GPRS support node (GGSN), an offline charging system, an online charging system, and so on.

Although the invention has been described in the context of particular embodiments, various modifications are possible without departing from the scope and spirit of the invention as defined by the appended claims. It should be appreciated that whilst embodiments of the present invention have mainly been described in relation to mobile communication devices such as mobile stations, embodiments of the present invention may be applicable to other types of communication devices that may access communication networks. Furthermore, embodiments may be applicable to other appropriate communication systems, even if reference has mainly been made to mobile communication systems.

1. A method for controlling access in a communication system, the method comprising:
providing an access route via at least one unlicensed radio spectrum access network and via at least one licensed radio spectrum access network;
receiving an access request from the at least one unlicensed radio spectrum access network or -the at least one licensed radio spectrum access network;
determining whether the access request is received from a cell belonging to the at least one unlicensed radio spectrum access network or the at least one licensed radio spectrum access network; and
controlling an access based on a result of the step of the determining.

2. The method according to claim 1, wherein the step of providing comprises providing the access route via unlicensed mobile access and via general packet radio service.

3. The method according to claim 1, wherein the step of determining comprises verifying a list comprising an identification of each cell belonging to the at least one unlicensed radio spectrum access network and determining that the access request is received from the at least one unlicensed radio spectrum access network when said cell is found on the list.

4. The method according to claim 3, wherein the step of determining comprises verifying the list comprises a routing area identity of cells belonging to the at least one unlicensed radio spectrum access network.

5. The method according to claim 1, wherein the step of receiving comprises receiving the access request over an interface from a controller comprising one of an unlicensed mobile access network controller and radio network controller.

6. The method according to claim 5, wherein the step of determining comprises determining an identification of the controller from which the access request is received, verifying a list comprising an identification of each unlicensed mobile access network controller belonging to the at least one unlicensed radio spectrum access network and determining that the access request is received from the at least one unlicensed radio spectrum access network when a controller network element is found on the list.

7. The method according to claim 1, further comprising receiving location information when the access route changes.

8. The method according to claim 1, further comprising receiving information on the at least one unlicensed radio spectrum access network through an interface when the cell is setup.

9. The method according to claim 1, further comprising receiving information on the at least one unlicensed radio spectrum access network in uplink packets through an interface together with a cell identifier.

10. The method according to claim 1, wherein:
the step of receiving comprises receiving the access request over a an interface from a network element; and
the step of determining comprises
determining an identification of the network element;
verifying a list comprising an identification of each network service element associated with an unlicensed mobile access network controller, wherein the network service element is dedicated for unlicensed mobile access; and
determining that the access request is received from the cell belonging to the at least one unlicensed radio spectrum access network when the network service element is found on the list.

11. The method according to claim 1, further comprising receiving access restriction information for a subscriber from a subscriber database associated with the subscriber, wherein the access restriction information comprises information on at least one of access restrictions and access permissions from at least one unlicensed mobile access network.

12. The method according to claim 1, further comprising generating charging information based on the result of the step of determining.

13. The method according to claim 1, wherein the step of controlling comprises controlling at least one parameter based on the result of the step of determining.

14. The method according to claim 13, wherein the step of controlling comprises controlling at least one of timer parameters, retransmission procedures, international mobile equipment identity check related parameters, authentication related parameters, overload control related parameters, subscriber count and subscriber throughput.

15. A computer program embodied on a computer-readable medium, the computer program configured to control a computing means to perform the steps of:
providing an access route via at least one unlicensed radio spectrum access network and via at least one licensed radio spectrum access network;
receiving an access request from the at least one unlicensed radio spectrum access network or the at least one licensed radio spectrum access network;
determining whether the access request is received from a cell belonging to the at least one unlicensed radio spectrum access network or the at least one licensed radio spectrum access network; and
controlling an access based on a result of the step of determining.

16. A network entity for a communication system, the network entity configured to:
provide an access route via at least one unlicensed radio spectrum access network and via at least one licensed radio spectrum access network;
receive an access request from the at least one unlicensed radio spectrum access network or the at least one licensed radio spectrum access network;
determine whether the access request is received from a cell belonging to the at least one unlicensed radio spectrum access network or the at least one licensed radio spectrum access network; and
control an access based on a result of the determining.

17. A network entity for a communication system, the network entity comprising:
providing means for providing an access route via at least one unlicensed radio spectrum access network and via at least one licensed radio spectrum access network;
receiving means for receiving an access request from the at least one unlicensed radio spectrum access network or the at least one licensed radio spectrum access network;
determining means for determining whether the access request is received from a cell belonging to the at least one unlicensed radio spectrum access network or the at least one licensed radio spectrum access network; and
controlling means for controlling an access based on a result of the determining.

18. A communication system comprising:
a first network entity configured to determine an access type from an access request received from one of a cell belonging to an unlicensed radio spectrum access network and a licensed radio spectrum access network, and to control an access according to said access type using access restriction information; and
a second network entity configured to provide the access restriction information for a subscriber associated with the access request, wherein the access restriction information comprises information on at least one of access restrictions and access permissions from at least one unlicensed mobile access network.
